(19) United States
(12) Patent Application Publication
(10) Pub. No.: US 2025/0256727 A1
(43) Pub. Date: Aug. 14, 2025

(54) POSITION ESTIMATION DEVICE, POSITION ESTIMATION METHOD, AND STORAGE MEDIUM STORING POSITION ESTIMATION PROGRAM

(71) Applicant: Mitsubishi Electric Corporation, Tokyo (JP)

(72) Inventors: Takashi OTA, Tokyo (JP); Ken MIYAMOTO, Tokyo (JP); Satoru TAKAHASHI, Tokyo (JP)

(73) Assignee: Mitsubishi Electric Corporation, Tokyo (JP)

(21) Appl. No.: 19/194,299

(22) Filed: Apr. 30, 2025

Related U.S. Application Data
(63) Continuation of application No. PCT/JP2022/045766, filed on Dec. 13, 2022.

(51) Int. Cl. B60W 40/12

(52) U.S. Cl. CPC B60W 40/12

(57) ABSTRACT

A position estimation device that estimates a position of a mobile object provided with a distance measurement sensor, includes processing circuitry to extract feature points from distance measurement data outputted from the distance measurement sensor to estimate restriction information indicating a direction in which posture assumed by a feature value of each of the feature points is restricted; to determine weights, to be respectively assigned to the feature points, based on the restriction information; and to calculate a rotation amount and a translation amount of the distance measurement data so that a sum of values obtained by respectively multiplying evaluation values representing differences by the weights is minimized, the differences being differences between the feature points of the distance measurement data and corresponding points respectively corresponding to the feature points in stored map information or previously measured distance data, and to estimate the position of the mobile object.

### CROSS-REFERENCE TO RELATED APPLICATION

This application is a continuation application of International Application No. PCT/JP2022/045766 having an international filing date of Dec. 13, 2022.

### BACKGROUND OF THE INVENTION

### 1. Field of the Invention

The present disclosure relates to a position estimation device, a position estimation method and a position estimation program.

### 2. Description of the Related Art

There has been proposed a positioning system including a reference data DB storing reference data, a feature point extraction unit that extracts feature points from a captured image that has captured scenery viewed from a vehicle, a captured image processing unit that generates feature point data in regard to each captured image from the feature points and outputs the feature point data as matching data for matching, and a scenery matching unit that performs the matching between reference data extracted from the reference data DB and the matching data and determines the position of the host vehicle based on a photographing position associated with reference data that succeeded in the matched (see Patent Reference 1, for example). In this positioning system, at the time of constructing the reference data DB, weights are assigned to the feature points based on distribution of the feature points or the like.

Patent Reference 1: Japanese Patent Application Publication No. 2011-215972 (see paragraphs 0016 to 0019, for example). However, in the conventional positioning system described above, at the time of the position estimation based on sensor data from a distance measurement sensor (e.g., LiDAR, camera or the like), the position is estimated without considering the most recent posture of the distance measurement sensor. Therefore, the conventional positioning system is incapable of obtaining position information with high accuracy.

### SUMMARY OF THE INVENTION

An object of the present disclosure, which has been made to resolve problems like that described above, is to provide a position estimation device, a position estimation method and a position estimation program that make it possible to increase the accuracy of the position estimation.

A position estimation device in the present disclosure is a device that estimates a position of a mobile object provided with a distance measurement sensor that detects a surrounding environment. The position estimation device includes processing circuitry to extract a plurality of feature points from distance measurement data outputted from the distance measurement sensor to estimate restriction information indicating a direction in which posture assumed by a feature value of each of the plurality of feature points is restricted by using a SHOT method, when calculating the posture of the distance measurement sensor based on the plurality of feature points; to determine a plurality of weights, to be respectively assigned to the plurality of feature points, based on the restriction information indicating a restriction direction in which the posture is restricted; and to calculate a rotation amount and a translation amount of the distance measurement data so that a sum of values obtained by respectively multiplying a plurality of evaluation values representing differences by the plurality of weights is minimized, the differences being differences between the plurality of feature points of the distance measurement data and a plurality of corresponding points respectively corresponding to the plurality of feature points in stored map information or previously measured distance data, and to estimate the position of the mobile object by using the rotation amount and the translation amount.

A position estimation method in the present disclosure is a method to be executed by a position estimation device that estimates a position of a mobile object provided with a distance measurement sensor that detects a surrounding environment. The method includes extracting a plurality of feature points from distance measurement data outputted from the distance measurement sensor; estimating restriction information indicating a direction in which posture assumed by a feature value of each of the plurality of feature points is restricted by using a SHOT method, when calculating the posture of the distance measurement sensor based on the plurality of feature points; determining a plurality of weights, to be respectively assigned to the plurality of feature points, based on the restriction information indicating a restriction direction in which the posture is restricted; and calculating a rotation amount and a translation amount of the distance measurement data so that a sum of values obtained by respectively multiplying a plurality of evaluation values representing differences by the plurality of weights is minimized, the differences being differences between the plurality of feature points of the distance measurement data and a plurality of corresponding points respectively corresponding to the plurality of feature points in stored map information or previously measured distance data, and to estimate the position of the mobile object by using the rotation amount and the translation amount.

### Effect of the Invention

According to the present disclosure, the accuracy of the position estimation can be increased.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing an example in which a position estimation device according to a first embodiment is mounted on a vehicle as a mobile object;

FIG. 2 is a block diagram schematically showing the configuration of the position estimation device according to the first embodiment;

FIG. 3 is a diagram showing an example of the hardware configuration of the position estimation device according to the first embodiment;

FIG. 4 is a diagram showing an example of a plurality of feature points obtained by a feature extraction unit in FIG. 2;

FIGS. 5A and 5B are schematic diagrams showing an estimated axial direction of a posture at each feature point;

FIGS. 6A and 6B are schematic diagrams showing a histogram in regard to normal vectors of feature points in each region and frequency information in regard to each restriction that each feature point in the respective region has;

FIG. 7 is a flowchart showing the operation of the position estimation device according to the first embodiment; and

FIG. 8 is a diagram showing an example in which a position estimation device according to a second embodiment is mounted on a three-dimensional measurement device as the mobile object.

### DETAILED DESCRIPTION OF THE INVENTION

A position estimation device, a position estimation method and a position estimation program according to each embodiment will be described below with reference to the drawings. The following embodiments are just examples and it is possible to appropriately combine embodiments and appropriately modify each embodiment.

### <1> First Embodiment

### <1-1> Configuration

### (General Outline of Position Estimation Device 11)

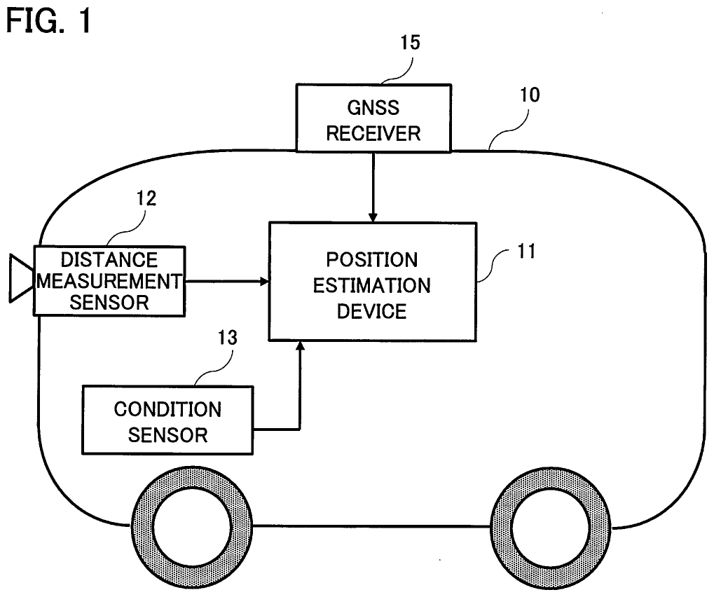

FIG. 1 is a diagram showing an example in which a position estimation device 11 according to a first embodiment is mounted on a vehicle as a mobile object 10. As shown in FIG. 1, the mobile object 10 includes a position estimation system that estimates its own position. The position estimation system includes a distance measurement sensor 12 that measures a surrounding environment, a condition sensor 13 that acquires a steering angle, speed, acceleration and so forth of the mobile object, a GNSS receiver 15 as a position information receiver that acquires an absolute position of the mobile object 10 from a GNSS (Global Navigation Satellite System), and the position estimation device 11 that executes processing such as the position estimation based on sensor data acquired from the distance measurement sensor 12, the condition sensor 13 and the GNSS receiver 15. The distance measurement sensor 12 includes one or more out of a LiDAR (Light Detection and Ranging) 121, a camera 122 and a millimeter-wave radar 123. The condition sensor 13 may include an inertial sensor that obtains inertial information regarding the mobile object. The mobile object 10 can be an autonomous driving vehicle, a PMV (Personal Mobility Vehicle), an AMR (Autonomous Mobile Robot), a drone as an unmanned aircraft, or the like, for example.

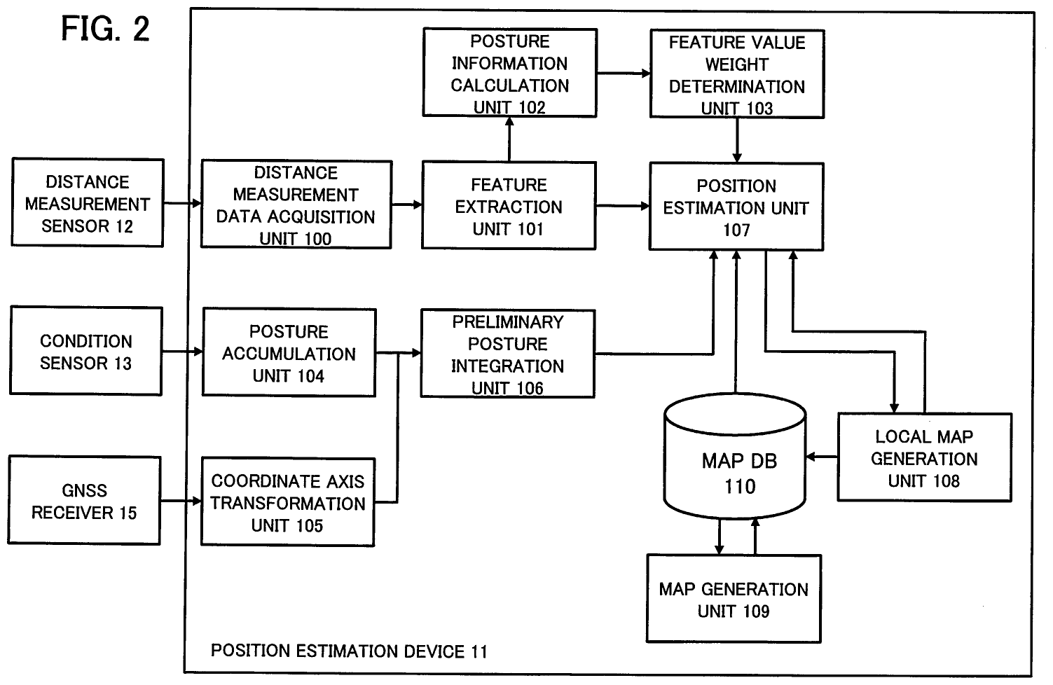

FIG. 2 is a block diagram schematically showing the configuration of the position estimation device 11 according to the first embodiment. The position estimation device 11 is a device that executes a position estimation method according to the first embodiment, such as a computer that executes a position estimation program according to the first embodiment, for example. As shown in FIG. 2, the position estimation device 11 includes a distance measurement data acquisition unit 100 that acquires distance measurement data as the sensor data from the distance measurement sensor 12, a feature extraction unit 101 that extracts feature points (and their feature values) from the distance measurement data, a posture information calculation unit 102 that calculates posture information regarding posture (i.e., posture of the distance measurement sensor 12, that is, posture of the mobile object 10) based on distribution of the extracted feature points, a feature value weight determination unit 103, a position estimation unit 107, a local map generation unit 108, a map generation unit 109, and a map database (map DB) 110. Further, the position estimation device 11 includes a posture accumulation unit 104 that acquires condition information from the condition sensor 13, a coordinate axis transformation unit 105 that acquires position information (absolute position information) from the GNSS receiver 15, and a preliminary posture integration unit 106. The map database 110 may also be provided in an external storage device.

The position estimation device 11 estimates the position of the mobile object 10 including at least the distance measurement sensor 12 that detects the surrounding environment. The position estimation device 11 includes the feature extraction unit 101 that extracts a plurality of feature points from the distance measurement data outputted from the distance measurement sensor 12, the posture information calculation unit 102 that calculates the posture information indicating the posture of the distance measurement sensor 12 (i.e., the posture of the mobile object 10) based on the plurality of feature points F, the feature value weight determination unit 103 that determines a plurality of weights W_{feature}, to be respectively assigned to the plurality of feature points F, based on the distribution of the plurality of feature points F, and the position estimation unit 107 that estimates the position of the mobile object 10 based on the plurality of feature points F of the distance measurement data, a plurality of corresponding points in the stored map information respectively corresponding to the plurality of feature points F, the calculated posture information, and the plurality of weights W_{feature}. The posture information, the plurality of feature points F and the plurality of weights W_{feature} will be described later.

Further, the position estimation unit 107 estimates the position of the mobile object 10, including the distance measurement sensor 12 that detects position posture information indicating the position and posture of the distance measurement sensor 12, based on condition data outputted from the condition sensor 13 included in the mobile object 10 and position data outputted from the GNSS receiver 15 included in the mobile object 10. The position estimation unit 107 uses the position posture information, obtained by integrating the condition data outputted from the condition sensor 13 included in the mobile object 10 and the position data outputted from the GNSS receiver 15 included in the mobile object 10, as an initial value in matching between the plurality of feature points F and the plurality of corresponding points.

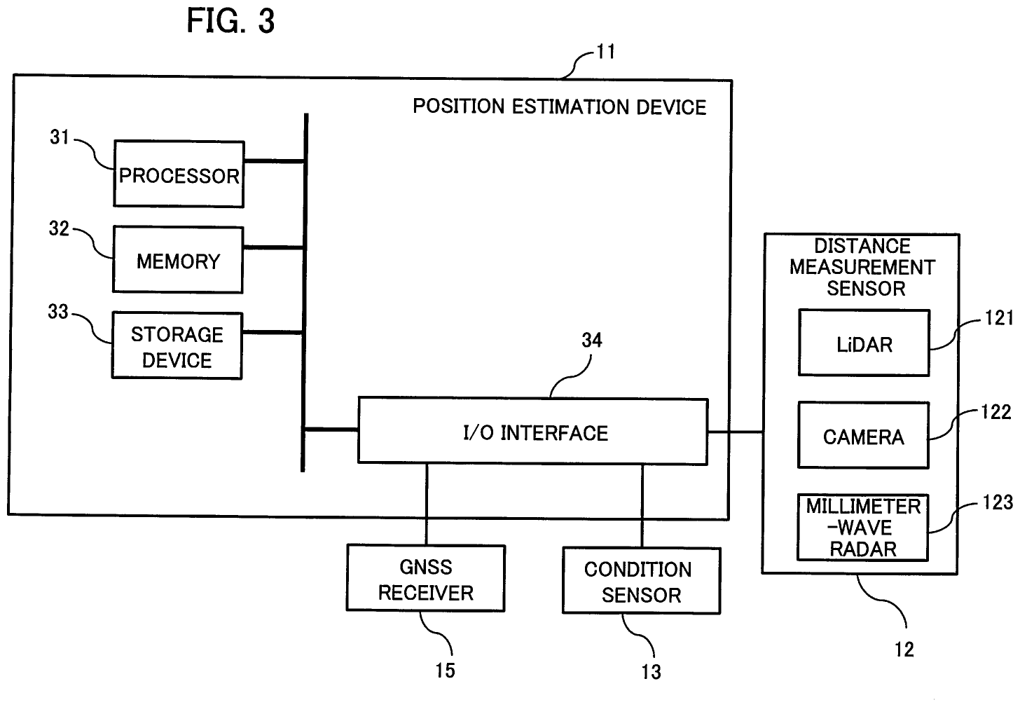

FIG. 3 is a diagram showing an example of the hardware configuration of the position estimation device 11 according to the first embodiment. The position estimation device 11 includes, for example, a processor 31 such as a CPU (Central Processing Unit), a memory 32, a nonvolatile storage device 33, and an input-output (I/O) interface 34. Parts constituting the position estimation device 11 are formed with processing circuitry, for example. The processing circuitry can either be dedicated hardware or include a CPU that executes a program (e.g., position estimation program) stored in the memory 32. The processor 31 implements functional blocks shown in FIG. 2.

The memory 32 is a semiconductor memory such as a RAM (Random Access Memory), for example, and the storage device 33 is an HDD (Hard Disk Drive), an SSD (Solid State Drive) or the like. The position estimation device 11 can also be a mixture of components made with processing circuitry and components made with a processor. Further, part or the whole of the position estimation device 11 can be a server computer on a network. Incidentally, the position estimation program is provided by means of downloading via a network, or through a storage medium (i.e., a recording medium) storing information such as a USB memory. The storage record medium is a non-transitory computer-readable storage medium (as a non-transitory tangible medium) storing a program such as the position estimation program. The hardware configuration in FIG. 3 is just an illustration and thus modification is possible.

When estimating the position of the mobile object 10, the processing circuitry including the processor 31 of the position estimation device 11 extracts a plurality of feature points from distance measurement data outputted from the distance measurement sensor 12; estimates restriction information indicating a direction in which posture assumed by a feature value of each of the plurality of feature points is restricted by using a SHOT method, when calculating the posture of the distance measurement sensor 12 based on the plurality of feature points; determines a plurality of weights, to be respectively assigned to the plurality of feature points, based on the restriction information indicating a restriction direction in which the posture is restricted; and calculates a rotation amount and a translation amount of the distance measurement data so that a sum of values obtained by respectively multiplying a plurality of evaluation values representing differences by the plurality of weights is minimized, the differences being differences between the plurality of feature points of the distance measurement data and a plurality of corresponding points respectively corresponding to the plurality of feature points in stored map information or previously measured distance data, and to estimate the position of the mobile object 10 by using the rotation amount and the translation amount.

### (Condition Sensor 13)

The condition sensor 13 includes an IMU (Inertial Measurement Unit) mounted on the mobile object 10, a sensor that measures a kinetic condition of the mobile object 10, or the like. The condition data as the sensor data obtained by the condition sensor 13 is sent to the memory 32 via the input-output interface 34 and temporarily stored in the memory 32. The condition data stored in the memory 32 is called up by the posture accumulation unit 104 and is used for the calculation of the posture of the mobile object 10. Concrete examples of the sensor that measures the kinetic condition are sensors that detect input information to the mobile object 10, such as a speed sensor like a speedometer and a rotary encoder that detects the steering angle; however, the sensor may include other types of sensors. Kinetic condition data stored in the memory 32 is called up by the posture accumulation unit 104 and is used for the calculation of the posture of the mobile object 10.

### (Distance Measurement Sensor 12)

The distance measurement sensor 12, such as a LiDAR (Light Detection and Ranging) mounted on the mobile object 10, a camera as an image capturing device, a millimeter-wave radar, or a sonar (Sound Navigation and Ranging), acquires surrounding environment information by detecting the environment surrounding the mobile object 10. The distance measurement data obtained by the distance measurement sensor 12 is sent to the memory 32 via the input-output interface 34 and temporarily stored in the memory 32. The distance measurement data stored in the memory 32 is called up by the feature extraction unit 101 and is used for the calculation of the posture information on the mobile object 10.

### (Distance Measurement Data Acquisition Unit 100)

The distance measurement data acquisition unit 100 receives the distance measurement data as the sensor data transmitted from the distance measurement sensor 12 and converts the distance measurement data to data in a prescribed data format. While a generic communication standard such as serial communication or Ethernet can be used for the communication of the distance measurement data, it is also possible to use an original communication standard. The distance measurement data received by the distance measurement data acquisition unit 100 is temporarily stored in a buffer, thereafter converted to the prescribed data format, and outputted to the feature extraction unit 101.

### (Feature Extraction Unit 101)

The feature extraction unit 101 extracts various types of feature values from the distance measurement data inputted from the distance measurement data acquisition unit 100. In the case where the distance measurement sensor 12 is a LiDAR, three-dimensional features (edges, corners and planes) obtained from point cloud data including a plurality of feature points are used; however, it is also possible to use other feature values. The feature extraction unit 101 outputs the extracted various types of feature values to the posture information calculation unit 102.

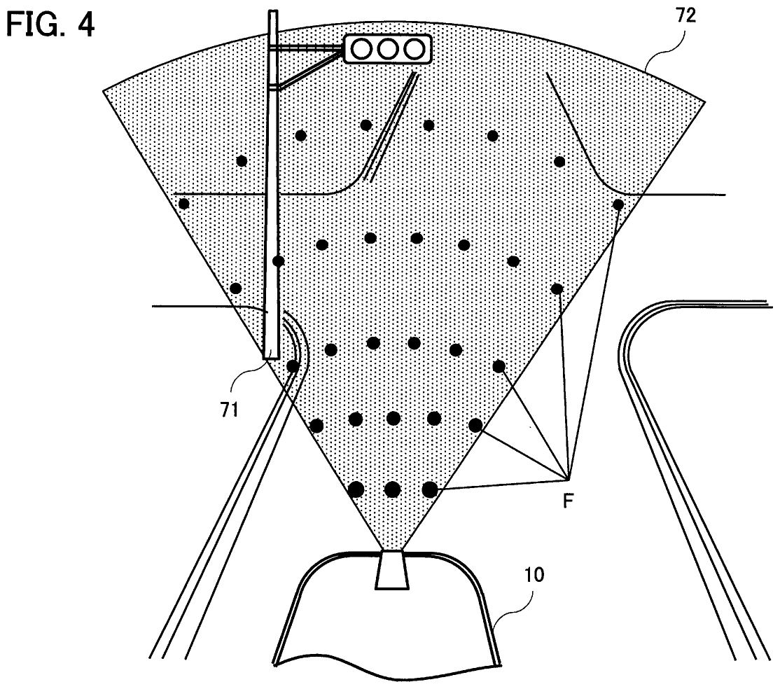

FIG. 4 is a diagram showing an example of the plurality of feature points F (a plurality of black circles in a photographing range 72) obtained by the feature extraction unit 101 in FIG. 2. This example shows an environment in which there is a bias in the distribution of the feature points F in each region as viewed from the mobile object 10 traveling ahead towards an intersection where there are things such as a traffic light 71. In such cases where the surrounding environment of the mobile object 10 includes a plurality of unevenly distributed feature points, or in an environment in which a feature is monotonous (e.g., floor surface or wall surface of a corridor in a monotonous shape, ground surface in an open site, or the like), the position estimation device 11 is likely to cause a situation of falling into a local solution at the time of the position estimation. Therefore, the position estimation device 11 in the first embodiment includes the position estimation unit 107 that estimates the position of the mobile object 10 based on the plurality of feature points F of the distance measurement data, the plurality of corresponding points in the stored map information respectively corresponding to the plurality of feature points F, the calculated posture information, and the plurality of weights W_{feature}.

### (Posture Information Calculation Unit 102)

The posture information calculation unit 102 calculates the weight (i.e., weight coefficient) of each feature point based on restriction information indicating a direction in which posture assumed by the feature value of each feature point F extracted by the feature extraction unit 101 is restricted. As a concrete example, when a plane is used as a feature point, the feature value is represented by a normal vector to each point. An evaluation function in the matching when using a plane as a feature point is in many cases represented by the plane and the length of a perpendicular line meeting the plane.

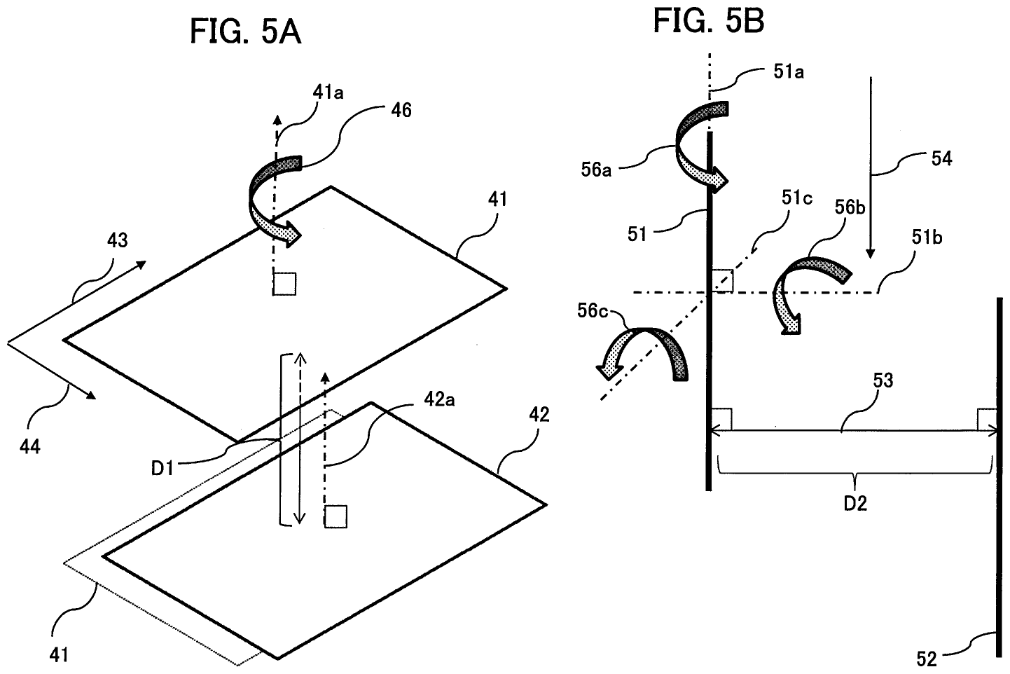

FIGS. 5A and 5B are schematic diagrams showing an estimated axial direction of the posture at each feature point. As shown in FIG. 5A, when a plane is used as a feature point in the estimation of the posture, the posture information estimated by using each feature point includes a movement amount (distance D1) in a normal direction (the direction of a normal line 41a and the direction of a normal line 42a) with respect to planes (plane 41 and plane 42) and rotation amounts of rotation (arrow 46) around the normal line 41a and rotations around rotation axes in two axial directions (the direction of an axis 43 and the direction of an axis 44) orthogonal to the normal direction.

Similarly, as shown in FIG. 5B, when a feature point at an edge is used as a feature point in the estimation of the posture, the evaluation function in the matching is considered by using a perpendicular line (normal line 53) extending from an edge (e.g., edge 51) to meet another edge (e.g., edge 52). In that case, the movement amount in a plane orthogonal to an edge (e.g., the edge 51) and rotations (rotations in directions of arrows 56a, 56b and 56c) around rotation axes in the edge direction (the direction of an axis 51a) and two axial directions (the direction of an axis 51b and the direction of an axis 51c) orthogonal to the edge direction can be obtained by calculation.

Therefore, when estimating the posture information on the mobile object 10 in the present frame from data in the previous frame based on the feature points shown in FIGS. 5A and 5B, the posture information calculation unit 102 is capable of estimating in which axial direction the restriction is (i.e., which axial direction is a restriction direction). The posture information calculation unit 102 performs the weighting by considering the distribution of the feature points having such restrictions.

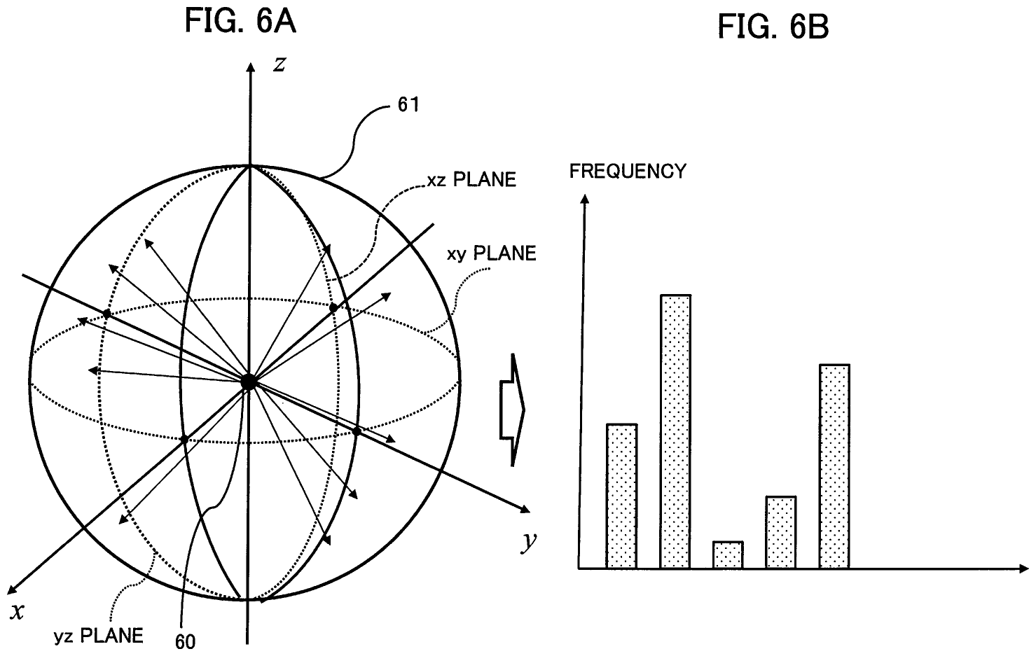

FIGS. 6A and 6B are schematic diagrams showing an example of a histogram in regard to normal vectors of feature points in each region and frequency information in regard to each restriction that each feature point has. The processing regarding the distribution of the feature points may be executed by using a method like SHOT (Signatures of Histograms of Orientations), for example. The SHOT is one type of a point cloud feature value that uses a histogram of the inner product between a neighborhood point set and a normal vector regarding a central point 60, included in each of eight regions obtained by splitting a sphere 61 defined around the central point 60 as a representative point (splitting at an xy plane, a yz plane and an xz plane into eight regions), as the feature, and the frequency information in regard to each restriction that each feature point has can be obtained by generating the eight regions obtained by bisecting the sphere 61 respectively around the xyz-axes in a certain local coordinate system and generating the histogram of the normal vectors of the feature points in each region as shown in FIGS. 6A and 6B according to this method. Here, in FIG. 6B, the vertical axis represents the histogram and the horizontal axis represents the feature value (the direction restricted by the feature point).

Further, as a method other than the method using a histogram like the SHOT, it is possible, for example, to generate a three-dimensional normal distribution based on feature points based on normal vectors of plane features and use the frequency of each feature point. The obtained histogram is outputted to the feature value weight determination unit 103.

### (Feature Value Weight Determination Unit 103)

The feature value weight determination unit 103 performs the weighting in regard to each feature point based on the histogram calculated by the posture information calculation unit 102. As a method of calculating the weight W_{feature} based on the histogram, it is possible, for example, to set the weight based on the frequency in the histogram as shown in the following expression (1):

$${w}_{feature} = \frac{1}{1 + f} . \qquad ( 1 )$$

In the expression (1), W_{feature} represents the weight and f represents the frequency in the histogram. The frequency f is represented by a value, that is, a ratio, in a range from 0 to 1. The feature value weight determination unit 103 outputs the weight W_{feature} in regard to each feature point calculated according to the expression (1) to the position estimation unit 107.

### (Posture Accumulation Unit 104)

The posture accumulation unit 104 calculates the posture information (e.g., speed, angular speed and roll-pitch-yaw) in the latest data frame by using the condition data as the sensor data received from the condition sensor 13. As the condition sensor 13, an inertial sensor such as an acceleration sensor or a gyro sensor can be used. In the case of using an inertial sensor, sensor data such as acceleration or angular speed is generally outputted as the condition data. Even though such a value does not directly represent the movement amount of the device, the latest posture information can be obtained by successively updating the posture information by integrating the condition data from the measurement start time. The posture accumulation unit 104 outputs the obtained posture information to the preliminary posture integration unit 106.

### (Coordinate Axis Transformation Unit 105)

The coordinate axis transformation unit 105 transforms latitude longitude information measured by the GNSS receiver 15 into a coordinate system to be used by the mobile object 10 for the own position estimation. For such coordinate systems, reference points as references have generally been set at various places around the world and a plane rectangular coordinate system having such a reference point as the origin is used in many cases. In Japan, for example, 19 reference points have been prepared and coordinate values in an xy coordinate system around each point as the reference are calculated by a predetermined calculation method (described in Non-patent Reference 1). The coordinate axis transformation unit 105 outputs the calculated position information to the preliminary posture integration unit 106.

Non-patent Reference 1: Kazushige Kawazu, “A More Concise Method of Calculation for the Coordinate Conversion between Geographic and Plane Rectangular Coordinates on the Gauss-Kruger Projection”, Journal of the Geospatial Information Authority of Japan, 2011, No. 121, pp. 109-124, URL: https://www.gsi.go.jp/common/000061216.pdf

### (Preliminary Posture Integration Unit 106)

The preliminary posture integration unit 106 calculates integrated position posture information based on the estimated posture information obtained by the posture accumulation unit 104 based on the condition data and the position information obtained by the coordinate axis transformation unit 105. While a Kalman filter or the like is generally used as the method of integrating multiple items of sensor information, it is also possible to employ a different method such as obtaining a weighted average based on variance values of the items of the estimated posture information or determining a representative value by means of a voting system.

### (Position Estimation Unit 107)

The position estimation unit 107 calls up the feature values extracted from the distance measurement data by the feature extraction unit 101 and local map information generated by the local map generation unit 108 which will be described later, searches for corresponding points between the map and newly measured distance measurement data, and estimates a posture that minimizes (or maximizes) a cost function representing the difference between these two point clouds.

As typical posture estimation methods, there are LOAM (Lidar Odometry and Mapping) as a method using a 3D LiDAR as the distance measurement sensor and Cartographer as a method using a 2D LiDAR as the distance measurement sensor. In these methods, the movement amount can be calculated generally by forming pairs of similar points between the latest distance measurement data and distance measurement data obtained in the immediately previous measurement or points that have been measured so far and obtaining rotation-translation that minimizes distances between the similar points in the pairs. Relationship between the similar points (feature points) can be represented as in the following expression (2):

$$y = R x + t . \qquad ( 2 )$$

In the expression (2), y represents the position of the feature point in the immediately previous distance measurement data, R represents a rotation matrix, x represents the position of the feature point in the latest distance measurement data, and t represents a translation vector.

This is equivalent to obtaining change amounts of the posture between two pieces of distance measurement data by obtaining a translation amount and a rotation amount that make the same points coincide with each other between the two pieces of distance measurement data. In reality, however, it is difficult to uniquely obtain the solutions since the number of equations becomes greater relative to the number of parameters desired to be obtained due to influence of noise or the like. Therefore, an evaluation function represented by the following expression (3) is used and solutions minimizing an evaluation value obtained by this evaluation function are obtained approximately:

$$min {\sum }_{i = 0}^{n} {‖ {y}_{i} - ( R {x}_{i} + t ) ‖}^{2} . \qquad ( 3 )$$

As a method for solving such a problem, it is generally possible to transform the expression into a computable form by using singular value decomposition (SVD) or the like and then obtain optimum solutions by an optimization method such as the Newton's method or the Levenberg-Marquardt algorithm. However, with the evaluation function in the expression (3), when feature points are concentrated on a particular surface or a particular edge, there is a possibility that the evaluation value obtained by the expression (3) becomes less than or equal to a threshold value even supposing that the rotation amount and the translation amount in a direction other the axial direction estimated by using those feature points have not converged.

Therefore, erroneous convergence of the calculation (i.e., the evaluation value erroneously becoming less than or equal to the threshold value) due to part of the feature points can be inhibited by using an expression obtained by adding weights wᵢ previously calculated respectively for the feature points as square error coefficients to the expression (3), such as the following expression (4):

$$min {\sum }_{i = 0}^{n} {w}_{i} {‖ {y}_{i} - ( R {x}_{i} + t ) ‖}^{2} . \qquad ( 4 )$$

### (Local Map Generation Unit 108)

When the position estimation unit 107 has already executed the position estimation and map information generated so far exists in the map DB 110, the local map generation unit 108 generates local map data regarding the vicinity of the own position of the mobile object 10 from these pieces of map information.

### (Map Generation Unit 109)

The map generation unit 109 performs coordinate transformation on the distance measurement data acquired by the distance measurement data acquisition unit 100 based on the posture information obtained when the calculation result (evaluation value) fell below the threshold value or a predetermined number of trials was exceeded in the position estimation unit 107. Then, the map generation unit 109 extends the map information by adding the distance measurement data after undergoing the coordinate transformation to the map DB 110.

The position estimation device 11 estimates the own position of the mobile object 10 by using the data acquired from the distance measurement sensor 12, the condition sensor 13 and the GNSS receiver 15 via the input-output interface 34. The position estimation device 11 estimates the change amounts of the posture (= (movement amount)+ (change amounts of roll-pitch-yaw)) by making the association between data frames by using the feature values extracted from the acquired distance measurement data, and estimates the own position with high accuracy by integrating the posture information acquired from the condition sensor 13 and the GNSS receiver 15.

### <1-2> Operation

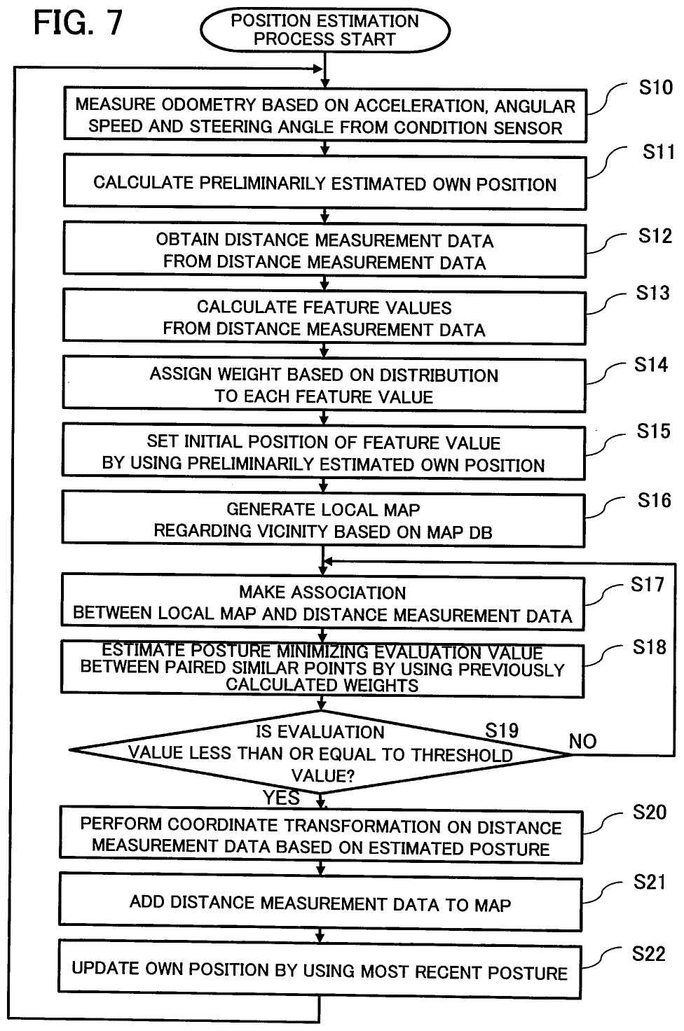

FIG. 7 is a flowchart showing the operation of the position estimation device 11 according to the first embodiment.

### (Step S10)

In step S10, the posture accumulation unit 104 calculates odometry based on the condition data as the sensor data acquired from the condition sensor 13 (e.g., information such as the acceleration, the angular speed or the steering angle). In parallel with this processing, the coordinate axis transformation unit 105 performs the coordinate transformation on the position information obtained by the GNSS receiver 15 and makes the coordinates after the transformation coincide with the coordinates of the position information calculated by the posture accumulation unit 104.

### (Step S11)

In step S11, the preliminary posture integration unit 106 integrates the information obtained by the condition sensor 13 and calculated by the posture accumulation unit 104 in the step S10 with the position information obtained by the GNSS receiver 15 and underwent the coordinate transformation in the step S10. As the method of the integration, a method using a Kalman filter or the like can be used, and the preliminary posture integration unit 106 outputs the result of the estimation to the position estimation unit 107 as a preliminarily estimated own position.

### (Step S12)

In step S12, the distance measurement data acquisition unit 100 receives the distance measurement data as the sensor data from the distance measurement sensor 12 and converts the received distance measurement data to distance measurement data as data in a predetermined format.

### (Step S13)

In step S13, the feature extraction unit 101 calculates the feature values to be used for the data matching between frames from the distance measurement data converted into the predetermined format in the step S12. For example, the feature extraction unit 101 calculates information such as a change amount of luminance and three-dimensional shapes (plane, edge, etc.) of the surrounding environment from the distance measurement data.

### (Step S14)

In step S14, the posture information calculation unit 102 calculates which posture each of the feature values detected by the feature extraction unit 101 has restriction on. Further, the feature value weight determination unit 103 sets the weight of each feature value to be used in the posture estimation as a subsequent process at a value in a range from 0 to 1 based on the information calculated by the posture information calculation unit 102.

### (Step S15)

In step S15, for the posture estimation to be executed by using the feature values calculated in the step S13, the position estimation unit 107 employs the posture information estimated by the preliminary posture integration unit 106 as the initial value of the matching.

### (Step S16)

In step S16, when the position estimation has been executed in the steps so far and map information generated so far exists in the map DB 110, the local map generation unit 108 generates the local map data regarding the vicinity of the own position of the mobile object 10 from these pieces of map information.

### (Step S17)

In step S17, the position estimation unit 107 searches for the feature values extracted in the step S13 and the corresponding points in the local map data generated in the step S16 respectively corresponding to the feature values and makes the association between each other.

### (Steps S18 and S19)

In step S18, the position estimation unit 107 calculates a posture that minimizes the evaluation value, obtained by the evaluation function between feature values associated in the step S17, by the iteration method. When the calculation result is not less than or equal to a previously set threshold value (No in step S19), the position estimation unit 107 executes the processing in the step S17 again, makes the association between feature values based on the estimated posture calculated most lately, and executes the processing in the step S18. When the calculation result has become less than or equal to the previously set threshold value (Yes in the step S19), the process advances to step S20.

### (Step S20)

In the step S20, the map generation unit 109 performs the coordinate transformation on the distance measurement data acquired by the distance measurement data acquisition unit 100 based on the posture obtained when the calculation result in the step S18 fell below the previously set threshold value or the predetermined number of trials was exceeded.

### (Step S21)

In step S21, the map generation unit 109 extends the map information by adding the distance measurement data after undergoing the coordinate transformation in the step S20 to the map DB 110.

### (Step S22)

In step S22, the position estimation unit 107 updates the own position of the mobile object 10 from the previous step based on the posture obtained in the step S18.

### <1-3> Effect

As described above, the position estimation device 11 according to the first embodiment applies a weight to the evaluation value at the time of the position estimation by assigning weights to the feature values. Therefore, the situation of falling into a local solution at the time of the position estimation caused by part of the feature points can be made unlikely to occur even in an environment in which there is a bias in the distribution of the feature points in each region or in an environment in which the feature is monotonous.

Further, the position estimation device 11 according to the first embodiment performs the weighting by using the posture information estimated by using the feature values and is thereby capable of appropriately making the data association between frames and further inhibiting the occurrence of the situation in which the posture estimation process falls into a local solution.

### <2> Second Embodiment

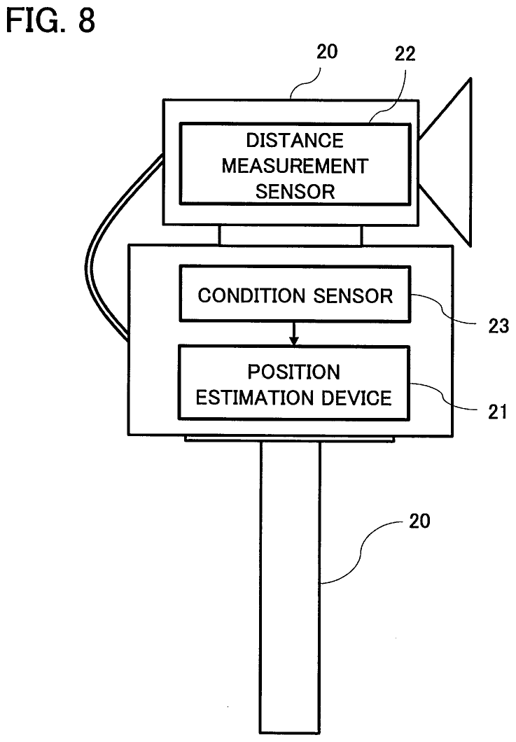

While the position estimation device is mounted on a vehicle as the mobile object in the first embodiment, a position estimation device in a second embodiment is mounted on a three-dimensional measurement device as the mobile object. FIG. 8 is a diagram showing an example of a case where a position estimation device 21 according to the second embodiment is mounted on a three-dimensional measurement device 20. In FIG. 8, the three-dimensional measurement device 20 includes a distance measurement sensor 22, a condition sensor 23 including an inertial sensor, the position estimation device 21, and a holding unit 24. The three-dimensional measurement device 20 may be equipped with a GNSS receiver. The position estimation device 21 has a configuration similar to the position estimation device 11 according to the first embodiment.

For example, the three-dimensional measurement device 20 is a measurement device for measuring the shape of a structure such as land, a road, a tunnel or a building or a detection device for detecting the change in the shape of a cliff, a mountain or the like. Further, since measurement while moving is performed in the three-dimensional measurement, the three-dimensional measurement device 20 is mounted on a work vehicle or is held and operated by a worker. The distance measurement sensor 12 described in the first embodiment can be used as the distance measurement sensor 22. Similarly, the condition sensor 13 described in the first embodiment can be used as the condition sensor 23. The position estimation device 21 is used for estimating the posture of the three-dimensional measurement device 20 and is capable of adjusting parameters to suit measurement properties of the three-dimensional measurement device on the basis of the configuration described in the first embodiment. The holding unit 24 is a structure for holding the three-dimensional measurement device 20, such as a stand for fixing the three-dimensional measurement device 20 to the work vehicle or a handle grip used for gripping the three-dimensional measurement device 20 with a hand, for example.

With the configuration in the second embodiment, the situation of falling into a local solution at the time of the position estimation caused by part of the feature points can be made unlikely to occur even in an environment in which there is a bias in the distribution of the feature points in each region or the feature is monotonous, such as flat land, a cliff, or a tunnel. Accordingly, the measurement accuracy of the three-dimensional measurement device can be increased.

### DESCRIPTION OF REFERENCE CHARACTERS

10: mobile object, 11: position estimation device, 12: distance measurement sensor, 121: LiDAR, 122: camera, 123: millimeter-wave radar, 13: condition sensor, 15: GNSS receiver (position information receiver), 20: three-dimensional measurement device (mobile object), 21: position estimation device, 22: distance measurement sensor, 23: condition sensor, 24: holding unit, 31: processor, 32: memory, 33: storage device, 34: input-output interface, 100: distance measurement data acquisition unit, 101: feature extraction unit, 102: posture information calculation unit, 103: feature value weight determination unit, 104: posture accumulation unit, 105: coordinate axis transformation unit, 106: preliminary posture integration unit, 107: position estimation unit, 108: local map generation unit, 109: map generation unit, 110: map DB.

What is claimed is:

1. A position estimation device that estimates a position of a mobile object provided with a distance measurement sensor that detects a surrounding environment, the position estimation device comprising:
processing circuitry
to extract a plurality of feature points from distance measurement data outputted from the distance measurement sensor to estimate restriction information indicating a direction in which posture assumed by a feature value of each of the plurality of feature points is restricted by using a SHOT method, when calculating the posture of the distance measurement sensor based on the plurality of feature points;
to determine a plurality of weights, to be respectively assigned to the plurality of feature points, based on the restriction information indicating a restriction direction in which the posture is restricted; and
to calculate a rotation amount and a translation amount of the distance measurement data so that a sum of values obtained by respectively multiplying a plurality of evaluation values representing differences by the plurality of weights is minimized, the differences being differences between the plurality of feature points of the distance measurement data and a plurality of corresponding points respectively corresponding to the plurality of feature points in stored map information or previously measured distance data, and to estimate the position of the mobile object by using the rotation amount and the translation amount.

2. The position estimation device according to claim 1, wherein the processing circuitry uses position posture information, obtained by integrating condition data outputted from a condition sensor included in the mobile object with position data outputted from a position information receiver included in the mobile object, as an initial value in matching between the plurality of feature points and the plurality of corresponding points.

3. The position estimation device according to claim 1, wherein the mobile object is a vehicle.

4. The position estimation device according to claim 1, wherein the mobile object is a three-dimensional measurement device.

5. A position estimation method to be executed by a position estimation device that estimates a position of a mobile object provided with a distance measurement sensor that detects a surrounding environment, the method comprising:
extracting a plurality of feature points from distance measurement data outputted from the distance measurement sensor;
estimating restriction information indicating a direction in which posture assumed by a feature value of each of the plurality of feature points is restricted by using a SHOT method, when calculating the posture of the distance measurement sensor based on the plurality of feature points;
determining a plurality of weights, to be respectively assigned to the plurality of feature points, based on the restriction information indicating a restriction direction in which the posture is restricted; and
calculating a rotation amount and a translation amount of the distance measurement data so that a sum of values obtained by respectively multiplying a plurality of evaluation values representing differences by the plurality of weights is minimized, the differences being differences between the plurality of feature points of the distance measurement data and a plurality of corresponding points respectively corresponding to the plurality of feature points in stored map information or previously measured distance data, and to estimate the position of the mobile object by using the rotation amount and the translation amount.

6. A non-transitory computer-readable storage medium for storing a position estimation program that causes a computer, estimating a position of a mobile object provided with a distance measurement sensor that detects a surrounding environment, to execute:
extracting a plurality of feature points from distance measurement data outputted from the distance measurement sensor;
estimating restriction information indicating a direction in which posture assumed by a feature value of each of the plurality of feature points is restricted by using a SHOT method, when calculating the posture of the distance measurement sensor based on the plurality of feature points;
determining a plurality of weights, to be respectively assigned to the plurality of feature points, based on the restriction information indicating a restriction direction in which the posture is restricted; and
calculating a rotation amount and a translation amount of the distance measurement data so that a sum of values obtained by respectively multiplying a plurality of evaluation values representing differences by the plurality of weights is minimized, the differences being differences between the plurality of feature points of the distance measurement data and a plurality of corresponding points respectively corresponding to the plurality of feature points in stored map information or previously measured distance data, and to estimate the position of the mobile object by using the rotation amount and the translation amount.
